(19) United States
(12) Patent Application Publication
(10) Pub. No.: US 2007/0266915 A1
(43) Pub. Date: Nov. 22, 2007

(54) Partition wall structure of a furnace

(75) Inventors: Markku Roppo, Charlotte, NC (US); Pekka Lehtonen, Kotka (FI); Tero Luomaharju, Kammenniemi (FI)

Correspondence Address: VENABLE LLP, P.O. BOX 34385, WASHINGTON, DC, 20043-9998, US

(73) Assignee: Metso Power Oy, Tampere (FI)

(21) Appl. No.: 11/802,032

(22) Filed: May 18, 2007

(30) Foreign Application Priority Data
May 18, 2006 (FI) 20065332

(51) Int. Cl. F23G 7/00; F26B 7/00

(52) U.S. Cl. 110/243; 34/430

(57) ABSTRACT

A fluidized bed boiler, which comprises at least a furnace defined by walls, a grate and a roof, as well as a bed ash cooler. In addition, the fluidized bed boiler comprises at least a primarily vertical partition wall between the grate and the roof, and at least one of the walls of the bed ash cooler is formed of a part of the partition wall.

### CROSS-REFERENCE TO RELATED APPLICATIONS

This application claims priority under 35 USC §119 to Finnish Patent Application No. 20065332 filed on May 18, 2006.

### FIELD OF THE INVENTION

The invention relates to a fluidized bed boiler and to a method for forming a bed ash cooler of a fluidized bed boiler.

### BACKGROUND OF THE INVENTION

The furnace of a typical fluidized bed boiler comprises an inner part defined by side walls, a bottom and a roof. Some furnaces also comprise partition wall structures inside the furnace, which support the bottom of the boiler and/or add heat exchange surface area. In addition, a fluidized bed boiler comprises different feed means, with which fuel and air is fed to the furnace. Typically primary air is used as fluidizing gas, with which the fluidized bed material is fluidized. In addition to heat, the combustion process results in ash and other combustion products and residue. A part of these tends to deposit in the lower part of the furnace. This kind of materials, such as, for example, bed ash, must be removed from the furnace so that the combustion process can be maintained as desired.

In the known bed ash removal solutions a bed ash cooler is used. Ash from the fluidized bed is fed to the bed ash cooler in a suitable manner, such as via a connection at the upper part of the cooler. Typically the temperature of the ash in the bed ash cooler decreases from approximately 800-1,000° C. to 200-300° C. before the ash is removed from the cooler. The thermal energy recovered with the bed ash cooler can be utilized in various ways. For example, it can be used to heat the combustion air before directing to the furnace.

In known solutions the bed ash cooler is placed outside the furnace. In a known solution the bed ash cooler is placed in an external “pocket” of the furnace separated by a side wall. This kind of a structure reserves the lower part of the side wall, in which case other structures, such as, for example, start-up burners, must be placed higher. In addition, in larger furnaces the ash removal from the central part of the furnace is more difficult. However, in larger furnaces there is generally a need to remove ash from the middle part.

In another solution the bed ash cooler is placed in a separate unit in the furnace, to which unit the bed ash is fed from the furnace with a duct structure. Thus, the bed ash cooler in turn needs space from below the furnace, in which case the space required by the entire boiler structure increases.

### SUMMARY OF THE INVENTION

Now, a solution for implementing a bed ash cooler has been invented, which enables a compact boiler structure.

To attain this purpose, the fluidized bed boiler according to the invention comprises at least a furnace defined by walls, a grate and a roof, as well as a bed ash cooler, wherein the fluidized be boiler in addition comprises at least a primarily vertical partition wall between the grate and the roof, and at least one of the walls of the bed ash cooler is formed of a part of the partition wall. The method for forming a bed ash cooler of a fluidized bed boiler according to the invention, in turn, is primarily characterized in that the fluidized bed boiler comprises at least a furnace defined by walls, a grate and a roof, as well as a bed ash cooler, wherein the fluidized bed boiler in addition comprises at least a primarily vertical partition wall between the grate and the roof, and at least one of the walls of the bed ash cooler is formed of a part of the partition wall.

The different embodiments of the invention can be used in different configurations and in different environments and in connection with boilers using different fluidizing techniques. Hereinbelow the term fluidized bed boiler is used when referring to boilers based generally on fluidizing technology, such as, for example, boilers where circulating fluidized bed, i.e. CFB technique or bubbling fluidized bed, i.e. BFB technique are used, which are generally also referred to as circulating bed (CFB) and bubbling bed (BFB).

The basic idea of the invention is to integrate the bed ash cooler to the partition wall of the furnace in order to enable a structure that is as compact as possible. A basic idea of the invention is to form at least one of the walls of the bed ash cooler of the partition wall. The partition wall in question is arranged at least inside the furnace between the grate and the roof. In an embodiment the partition wall can continue outside the grate. Above the bed ash cooler the partition wall is primarily in a vertical position.

In an embodiment at least two of the walls of the bed ash cooler are formed of a partition wall. This can be implemented, for example, by bending a part of the pipes of the partition wall panel (second part of the pipes) into the second wall of the cooling chamber and by using the pipes that remain straight (the first part of the pipes) as the first wall. In another solution the pipes of the partition wall are divided by bending or by means of a supply/collection header to both directions. It is also possible to form several walls of the bed ash cooler of the partition wall. In an embodiment all the walls of the bed ash cooler are formed of the partition wall.

In another embodiment the bed ash cooler is inside the furnace and in another embodiment the bed ash cooler is below the furnace.

In an embodiment the lower part of the partition wall is arranged to decrease the surface area of the grate. This improves mixing in the fluidized bed area and the circulation of particulates. In an embodiment of the invention a slanted structure like the back and front walls of the furnace is formed of the lower part of the partition wall. In an embodiment the lower part of the partition wall narrows upwards. The structure can be implemented, for example, in such a manner that a part of the pipes of the partition wall panel are bent to the same angle as the pipes of the front and back walls and by using the straight pipes as another wall. It is also possible to divide the pipes of the partition wall by bending or by means of a supply/collection header both ways in such a manner that by means of them it is possible to narrow the two grate sections.

The different embodiments of the above-described solution separately and when combined in different ways provide different advantages. A solution, inter alia, enables placing the bed ash cooler in the furnace. Another embodiment, in turn, enables decreasing the surface area of the grate.

### DESCRIPTION OF THE DRAWINGS

In the following, the invention will be described in more detail with reference to the appended principle drawings, in which

FIG. 1 shows a fluidized bed boiler

FIG. 2 shows an embodiment according to the invention

FIG. 3 shows a horizontal cross-section of the embodiment according to FIG. 2 on level A-A, i.e. seen from above

FIG. 4 shows a vertical cross-section of the embodiment according to FIG. 2 on level B-B

FIG. 5 shows a cross-section of a bed ash cooler in a side view

FIG. 6 shows a vertical cross-section of the embodiment according to FIG. 5 on level C-C

FIG. 7 shows another embodiment

FIG. 8 shows a third embodiment

FIG. 9 shows an embodiment below the grate

FIG. 10 shows an application

For the sake of clarity, the figures only show the details necessary for understanding the invention. The structures and details that are not necessary for understanding the invention but are obvious for anyone skilled in the art have been omitted from the figures in order to emphasize the characteristics of the invention.

### DETAILED DESCRIPTION OF THE INVENTION

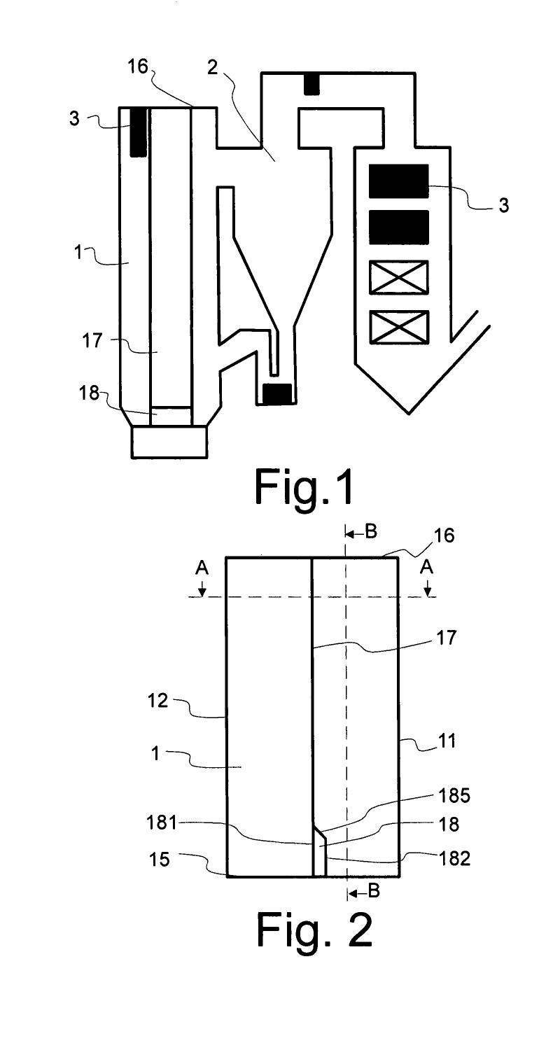

FIG. 1 shows a circulating fluidized bed boiler of fluidized bed boilers in a reduced manner. A circulating fluidized bed boiler comprises, inter alia, a furnace 1 and a cyclone 2, as well as different furnaces 3 at different phases. The invention relates primarily to the furnace 1 of the fluidized bed boiler and to its immediate vicinity.

FIG. 2 shows in principle a part of a boiler. The boiler comprises at least a furnace 1 defined by walls 11, 12, 13, 14, a grate 15 and a roof 16. The grate 15 is shown in the figures in a simplified manner. Inter alia, the fluidizing means typically connected to the grate 15 are not shown in the figures. The boiler also comprises means connected to feeding fuel and air, which can be on one or more levels on one or more walls 11, 12, 13, 14. These means are not shown in the figures either. In addition, the boiler comprises at least a mainly vertical partition wall 17 located between the grate 15 and the roof 16. Especially in large furnaces 1 pipe-panel-structured partition walls 15 extending from the grate 15 to the roof 16 are often used. The partition wall 17 is advantageously pipe-structured, in which case it is possible to connect medium circulation, such as, for example fluid and/or steam circulation, to it.

In addition, FIG. 2 shows a bed ash cooler 18 located in the lower part of the furnace 1. At lease one 181 of the walls of the bed ash cooler 18 is formed of a partition wall 17. It is also possible to implement the two walls 181, 182 of the bed ash cooler of the partition wall 17. This can be implemented, for example, by bending every other pipe of the partition wall panel into a second wall 182 of the cooling chamber 18 and by using the pipes that remain straight as the first wall 181. It is also possible that the first wall 181 comprises a different number of pipes than the second wall 182. Therefore, it can be considered that the partition wall 17 is formed of a first and a second part of the pipes, of which the first part forms the first wall of the bed ash cooler chamber 18 and the second part of the pipes forms the second wall of the bed ash cooler chamber 18. Advantageously the roof 185 of the bed ash cooler is also formed of the partition wall 17.

The bed ash cooler 18 can be formed of the pipes of the partition wall 17 by bending and/or by using different auxiliary structures, such as, for example supply and/or collection headers. In supply and collection headers two or more pipes are connected to each other. In addition, the number of pipes producing medium flow to the supply and collection headers may differ from the number of pipes taking medium away from the headers. For example, more pipes may leave the header than are coming in. Thus, it is, for example, possible to use more pipes in the walls of the bed ash cooler 18 than in the upper part of the partition wall 17. In an embodiment the pipes of the walls of the bed ash cooler 18 are connected to a collection header.

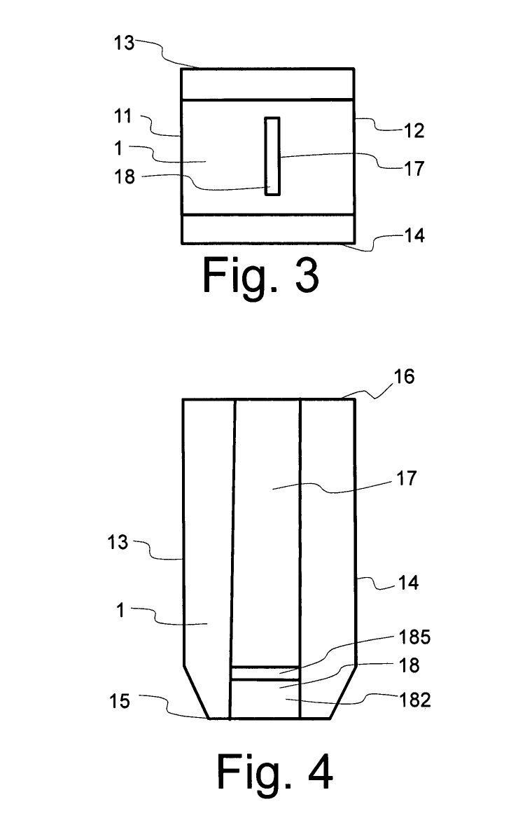

FIG. 3 shows a horizontal cross-section of a boiler according to FIG. 2 on level A-A, i.e. seen from above. The end walls 183, 184 of the bed ash cooler 18, i.e. the third and fourth walls can be implemented in various ways. They can be, for example, made as separate parts. If the cross-section of the partition wall 17 from above is, for example, L- or C-shaped, it is possible to utilize the partition wall also in implementing end walls 183, 184.

FIG. 4, in turn, shows a vertical cross-section of the boiler according to FIG. 2 on level B-B. As can be seen from FIGS. 3 and 4, the bed ash cooler 18 inside the furnace 1 does not in an advantageous embodiment reach the side walls 13, 14 of the furnace. Thus, the bed ash cooler 18 does not form inner corners in the furnace 1 that are problematic from the point of view of mixing, and the bed ash cooler does not significantly prevent the movement of particles. From the point of view of mixing it is also advantageous to use a partition wall 17 that does not extend from the side wall 13, 14 of the furnace to another. Advantageously both sides of the partition wall 17 are separate from the side walls 13, 14 of the furnace 1.

In some cases one side 183, 184 of the bed ash cooler 18 may extend to the side wall 13, 14 of the furnace. This type of a structure advantageously enables access to the bed ash cooler 18 from the outside of the furnace 1.

The input of the ash to be removed to the cooler chamber 18 can advantageously be arranged from either side. In an embodiment the ash is fed from the combustion chamber 1 to the ash cooler 18 via an inlet opening in the upper part of the cooler. The ash proceeds through the ash cooler 18 while cooling and is directed out of the outlet opening. In an embodiment of the bed ash cooler 18 the cooler comprises at least two cells, which are connected to each other via an opening. The number and dimensioning of the cells and openings can affect the capacity of the bed ash cooler 18 and the cooling effect.

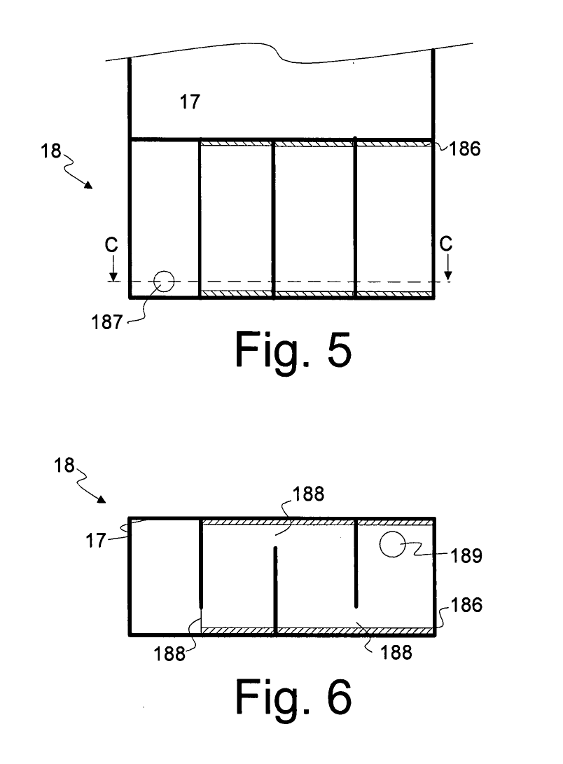

FIGS. 5 and 6 show the structure of a four-cell bed ash cooler 18 in principle. The number of cells can affect the air consumption of the bed ash cooler 18. With more cells it is possible to decrease air consumption in comparison to a solution with fewer cells in order to reach the same cooling effect. In the solution according to the invention fluidizing air is directed to the bed ash cooler 18, which air moves thermal energy from the ash to the other process. Advantageously air is directed via the bottom part of the bed ash cooler 18. The structures connected to air supply are not shown in the figures. The speed of the air flow fed to the bed ash cooler depends on the application. In an embodiment the air flow rate is around 0.5 to 2 m/s.

In the example shown in FIGS. 5 and 6 the walls of the first cell of the bed ash cooler 18 comprise piping of the partition wall 17, where the medium circulates. The inside of said cell is non-insulated or it is protected with a heat conductive refractory. The insides of the next cells are insulated from the piping of the partition wall with a suitable heat-insulating structure 186. With the insulations 186 of the cells the ash is prevented from heating in the bed ash cooler 18, because typically a high-pressure medium circulates in the pipes of the partition wall 17, the temperature of which medium is higher than the temperature of the ash cooled with the bed ash cooler.

The ash to be cooled is directed in the solution according to the example to the first cell via an opening 187 in the lower part of the cell wall. The ash moves from one cell to another via an opening 188 in the partition wall of cells. The opening 188 is advantageously located in the lower part of the partition wall and the openings of consecutive partition walls are advantageously collated in such a manner that they are located on opposite edges of the bed ash cooler 18. From the last cell the ash is removed via an outlet opening 189, which may be located on the bottom or on the wall of the cell. The location of the openings 188, 189 has been attempted to be illustrated in FIG. 6, which shows the cross-section of the bed ash cooler according to FIG. 5 on level C-C as seen from above. The openings 188 between the cells may also be located in a way that differs from that described above. In a solution ash is fed to two cells, which are located at different ends of the bed ash cooler. From these cells the ash is conveyed to the cell in the middle of the bed ash cooler, from which the ash is removed.

The cells of the bed ash cooler 18 may be located either adjacently or on different levels depending on the application. In addition, the bed ash cooler 18 may comprise different cleaning opening and/or cleaning means, with which, inter alia, the openings of the cells can be kept open during operation.

If necessary, it is possible to form a heat exchange surface in the bed ash cooler 18 by bringing steam pipes from below through the grate 15 or by bending cooling lines from the selected wall pipes of the cell, which lines return to the wall line.

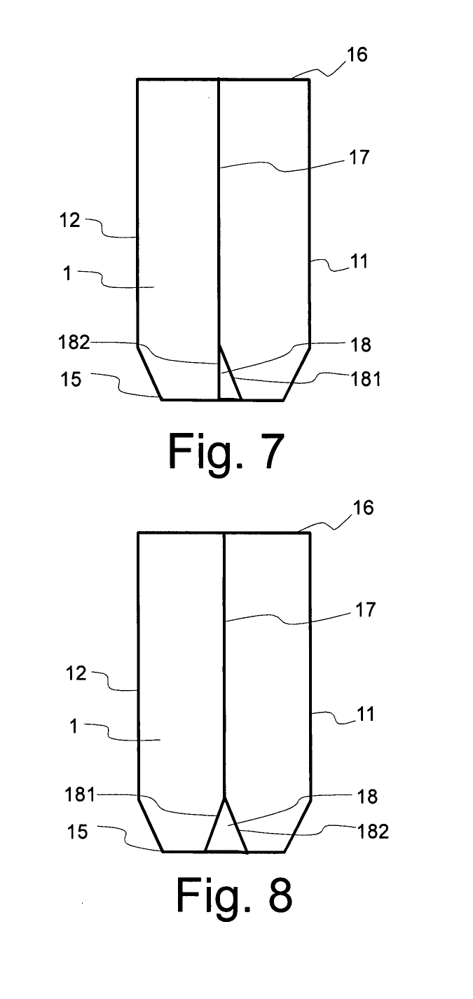

In circulating fluidized bed boilers a narrowing of the bottom part is used in the furnace 1 in order to decrease the surface area of the grate 15. This improves mixing in the fluidized bed area and the circulation of particulates. In an embodiment of the invention a slanted structure like the back and front walls 11, 12 of the furnace 1 is formed of the lower part of the partition wall 17. The structure can be implemented, for example, in such a manner that for the first wall 181 every other pipe of the partition wall panel 17 is bent to the same angle as the pipes of the front and back walls 11, 12 and by using the straight pipes as another wall 182, as shown in FIG. 7. It is also possible that the first wall 181 and the second wall 182 comprise a different number of pipes. In another solution shown in FIG. 8 the pipes of the partition wall 17 are divided by bending or by means of a supply/collection header both ways in such a manner that by means of them it is possible to narrow the two grate sections.

The narrowing part formed in the lower part of the partition wall 17 is used advantageously as a bed ash cooler 18. It is also possible to use the narrowing part for other purposes. For example, the narrowing part can be used to bring in air, additional material or circulating gas. In some cases it is possible to bring fuel via the narrowing part.

The above-described structure inside the furnace 1 can be used in connection with different boiler structures, such as, for example, in connection with circulating and bubbling fluidized bed boilers. With a corresponding structure it is possible to manufacture, for example, a cell in the middle of the furnace 1 of a fluidized bed boiler for a cooling heat delivery surface or ash removal.

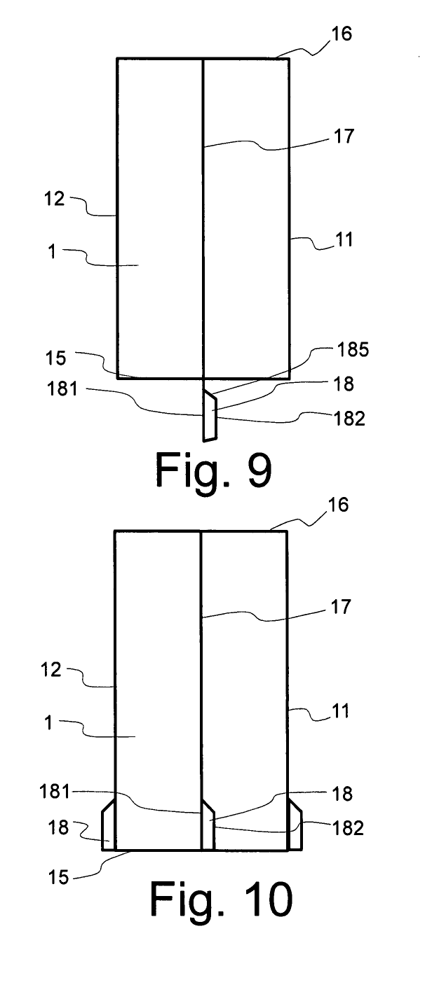

In an alternative structure the ash cooler chamber 18 is made below the grate 15, as shown in FIG. 9. Thus it is possible form the bottom, roof 185 and side walls 181, 182 (the first and second wall) of the ash cooler chamber 18 from the partition wall 17. The end walls 183, 184 (the third and fourth wall) of the ash cooler chambers 18 are, in turn, possible to form advantageously by using the wall pipes of the furnace 1. It is advantageous to leave space for primary air feeding between the grate 15 of the furnace 1 and the roof 185 of the ash cooler chamber 18.

The furnace 1 and the rest of the boiler may comprise other known structures irrespective of using the structure according to the invention. For example, in some applications there may be a need to place “pocket model” bed ash coolers in the walls 11, 12, 13, 14 of the furnace 1. Especially in large furnaces 1 it may be advantageous to use several bed ash coolers 18, a part of which may be located on the edges of the furnace and a part in the middle. The principle of this kind of a structure is shown in FIG. 10. The system may also comprise one or more bed ash coolers 18 located below the furnace 1.

By combining, in various ways, the modes and structures disclosed in connection with the different embodiments of the invention presented above, it is possible to produce various embodiments of the invention in accordance with the spirit of the invention. Therefore, the above-presented examples must not be interpreted as restrictive to the invention, but the embodiments of the invention may be freely varied within the scope of the inventive features presented in the claims hereinbelow.

1. A fluidized bed boiler, which comprises at least a furnace defined by walls, a grate and a roof, as well as a bed ash cooler, wherein the fluidized be boiler in addition comprises at least a primarily vertical partition wall between the grate and the roof, and at least one of the walls of the bed ash cooler is formed of a part of the partition wall.

2. The fluidized bed boiler according to claim 1, wherein the partition wall is pipe-structured.

3. The fluidized bed boiler according to claim 1, wherein the at least two of the walls of the bed ash cooler are formed of the partition wall.

4. The fluidized bed boiler according to claim 1, wherein the bed ash cooler is inside the furnace.

5. The fluidized bed boiler according to claim 4, wherein the lower part of the partition wall, which comprises the bed ash cooler, narrows upwards.

6. The fluidized bed boiler according to claim 4, wherein the bed ash cooler comprises several cells, at least two of which cells comprise an input for feeding bottom ash from the furnace to the cell.

7. The fluidized bed boiler according to claim 1, wherein the bed ash cooler is below the furnace.

8. The fluidized bed boiler according to claim 1, wherein the lower part of the partition wall is arranged to decrease the surface area of the grate.

9. The fluidized bed boiler according to claim 1, wherein the lower part of the partition wall, which comprises the bed ash cooler, narrows upwards.

10. The fluidized bed boiler according to claim 1, wherein the bed ash cooler comprises several cells, at least two of which cells comprise an input for feeding bottom ash from the furnace to the cell.

11. The fluidized bed boiler according to claim 1, wherein the fluidized bed boiler is a circulating fluidized bed boiler or a bubbling fluidized bed boiler.

12. A method for forming a bed ash cooler of a fluidized bed boiler, which fluidized bed boiler comprises at least a furnace defined by walls, a grate and a roof, as well as a bed ash cooler, wherein the fluidized bed boiler in addition comprises at least a primarily vertical partition wall between the grate and the roof, and at least one of the walls of the bed ash cooler is formed of a part of the partition wall.

13. The method according to claim 12, wherein the partition wall is pipe-structured and at least two of the walls of the bed ash cooler are formed of the partition wall by arranging the first part of the pipes as the first wall of the bed ash cooler and the second part of the pipes as the second wall of the bed ash cooler.
